(19) United States
(12) Patent Application Publication
(10) Pub. No.: US 2022/0245311 A1
(43) Pub. Date: Aug. 4, 2022

(54) DESIGN SUPPORT SYSTEM, DESIGN SUPPORT METHOD, AND RECORDING MEDIUM

(71) Applicant: Mitsubishi Electric Corporation, Chiyoda-ku, Tokyo (JP)

(72) Inventors: Satoru ISHIZAKA, Tokyo (JP); Yuji NAOMI, Tokyo (JP)

(73) Assignee: Mitsubishi Electric Corporation, Chiyoda-ku, Tokyo (JP)

(21) Appl. No.: 17/629,452

(22) PCT Filed: Aug. 31, 2020
(86) PCT No.: PCT/JP2020/032942

§ 371 Date: Jan. 24, 2022

(30) Foreign Application Priority Data
Sep. 2, 2019 (JP) PCT/JP2019/034386

(51) Int. Cl. G06F 30/27

(52) U.S. Cl. CPC G06F 30/27; G06F 2111/04

(57) ABSTRACT

A design support system includes variable extraction means and setting means. In the design support system, the variable extraction means extracts from verified design data a variable that defines design constraint. The setting means sets the design constraint by analyzing, using statistical processing or machine learning, a frequency distribution of the variable extracted by the variable extraction means.

### TECHNICAL FIELD

This disclosure relates to a design support system, a design support method, and a program.

### BACKGROUND ART

Design drawings indicating mechanisms of machines, circuit layouts of semiconductor devices, or the like include design information such as shapes, sizes, coordinates of mechanism components or components such as circuit elements or the like. Each component is to be arranged to observe design constraints predetermined so as not to cause a positional overlap, operational interference, or the like. A check is thus made to see if design choices comply with the design constraints.

However, a design constraint for putting distance between components is generally determined with margin added. This tends to cause an increase in space between the components. Thus in a case where a device is designed under a conventional design constraint, such designed device may have a size larger than a predetermined size or may be costly. Thus, in some cases, within a range in which the final performance can be expected to satisfy a target value, the design constraint may be relaxed by granting an exception to pass the design drawing and complete the design.

Patent Literature 1 discloses a circuit design support device that supports work for granting exception for relaxing a design constraint. This circuit design support device includes a pseudo-error registration file. When a user regards as not a real error the design choice determined by the circuit design support device as being non-compliant with the design constraint, the user registers the error in the pseudo-error registration file. When the design choice determined as an error in accordance with the design constraint is registered in the pseudo-error registration file, the circuit design support device cancels the error and gives the design choice a pass.

### CITATION LIST

### Patent Literature

Patent Literature 1: Unexamined Japanese Patent Application Publication No. H4-36866

### SUMMARY OF INVENTION

### Technical Problem

In the technique described in the patent literature, there is no references for determining whether the design choice determined as an error based on a design constraint is a real error or a false error. This causes the determination by the user to depend on an individual user. In addition, only when the design choices that are the same as the design choices determined as being non-compliant with the design rules are registered in the pseudo-error registration file, this technique determines that the error is not a real error, but in the other cases, determination by the user is required. This imposes an increased burden to the user.

In view of the above circumstances, an objective of the present disclosure is to enable easy setting of a design constraint.

### Solution to Problem

To achieve the above described objective, a design support system of the present disclosure includes variable extraction means for extracting from verified design data a variable that defines a design constraint; and setting means for setting the design constraint by analyzing, using statistical processing or machine learning, a frequency distribution of the variable extracted by the variable extraction means.

### Advantageous Effects of Invention

According to the present disclosure, the design constraint can be set by extracting from the verified design data the variable that defines the design constraint, and analyzing, using the statistical processing or the machine learning the frequency distribution of the extracted variable. Thus the design constraint can be easily set.

### BRIEF DESCRIPTION OF DRAWINGS

FIG. 1 is a configuration diagram of a design support system according to an embodiment of the present disclosure;

FIG. 2 is a diagram illustrating design data to be verified by the design support system illustrated in FIG. 1;

FIG. 3 is a diagram illustrating radii of circuit elements, distances between the circuit elements, and an outline distance between the circuit elements in the design drawing illustrated in FIG. 2;

FIG. 4 is a diagram illustrating an existence probability of the outline distance in the design data stored in a past design database (DB) illustrated in FIG. 1;

FIG. 5 is a diagram illustrating a discrete existence probability and its cumulative existence probability of the outline distance in the design data stored in the past design DB illustrated in FIG. 1;

FIG. 6 is a flowchart of a threshold calculation process executed by a threshold calculation device illustrated in FIG. 1;

FIG. 7 is a flowchart of a design verification process executed by a design verification device illustrated in FIG. 1;

FIG. 8 is a diagram illustrating another example of the existence probability of the outline distance in the design data stored in the past design DB illustrated in FIG. 1;

FIG. 9 is a diagram illustrating another example of the discrete existence probability and its cumulative existence probability of the outline distance in the design data stored in the past design DB illustrated in FIG. 1;

FIGS. 10A-10D are diagrams illustrating examples of variables and their existence probabilities according to Embodiment 2 of the present disclosure;

FIGS. 11A-11E are diagrams describing a process of a design support system according to Embodiment 3 of the present disclosure;

FIG. 12 is a diagram illustrating a process in a design support system according to Embodiment 4 of the present disclosure;

FIG. 13 is a diagram illustrating a configuration of data stored in a threshold DB of a design support system according to Embodiment 5 of the present disclosure;

FIG. 14 is a diagram illustrating an example of data stored in the past design DB according to Embodiment 6 of the present disclosure;

FIG. 15 is a diagram illustrating an example of design data and variables according to Embodiment 6;

FIG. 16 is a flowchart of a threshold calculation process executed by a threshold calculation device according to Embodiment 6;

FIG. 17 is a diagram illustrating an example of a frequency table according to Embodiment 6;

FIG. 18 is a diagram illustrating an example of a design constraint table according to Embodiment 6;

FIG. 19 is a diagram illustrating an example of a frequency distribution of pass/fail according to Embodiment 6;

FIG. 20 is a diagram illustrating an example of a correspondence between variables and design constraints according to Embodiment 7 of the present disclosure;

FIG. 21 is a flowchart of a verification process executed by a design verification device according to Embodiment 8 of the present disclosure;

FIG. 22 is a diagram illustrating a verification result output file according to Embodiment 8; and

FIG. 23 is a diagram illustrating an example of a hardware configuration of the design support system illustrated in FIG. 1.

### DESCRIPTION OF EMBODIMENTS

### Embodiment 1

A design support system, a design support method, and a program according to Embodiment 1 of the present disclosure are described below with reference to the drawings. To facilitate understanding, the following description is given assuming that a design target is a semiconductor device including a plurality of circuit elements.

The design support system and method according to the present embodiment searches for a relaxed design constraint so as to allow final performance of the design target to reach a target value without excessively surpassing the target value to determine the relaxed design constraint, and verifies design data. In the following description, to facilitate understanding, the following description is given assuming that the design constraint to be relaxed is an outline distance between circuit components. Also, to draw distinction, the design constraint set in a design phase are referred to as a first design constraint, and the design constraint relaxed in a range in which the final performance is expected to be able to satisfy the target value are referred to as a second design constraint.

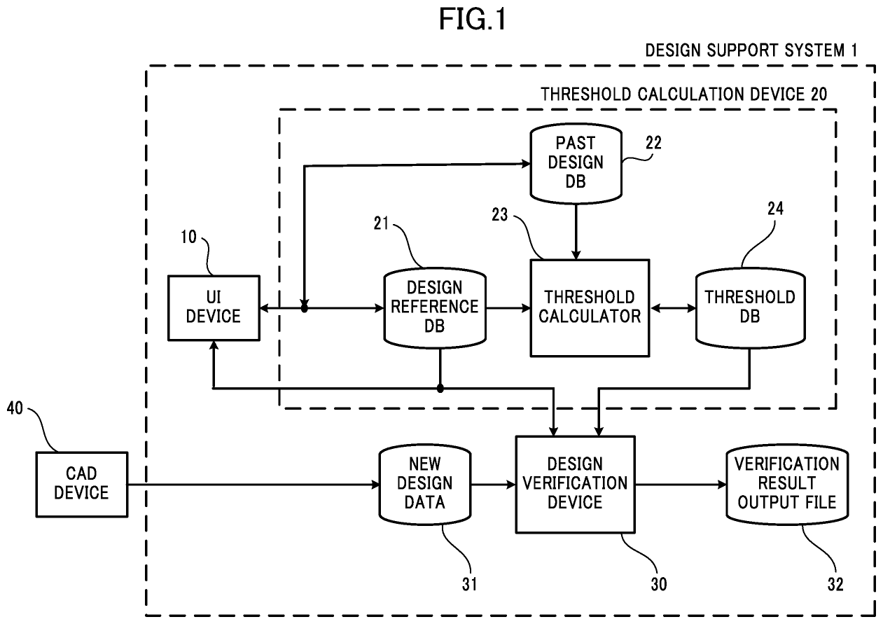

FIG. 1 illustrates a configuration of a design support system 1 according to Embodiment 1 of the present disclosure. As illustrated in FIG. 1, the design support system 1 includes a user interface (UI) device 10 that receives and outputs information, a threshold calculation device 20 that calculates the second design constraint, that is, the relaxed design constraint from similar past design data having already been verified for product shipment, and a design verification device 30 that verifies whether new design data 31 satisfies the design constraint.

The design support system 1 verifies the new design data 31 as passed when the outline distance between the circuit elements indicated by the new design data 31 does not satisfy the first design constraint that is the original design constraint but the outline distance satisfies the second design constraint that is a relaxed design constraint.

The new design data 31 is created and supplied by a computer aided design (CAD) device 40 for semiconductor device design.

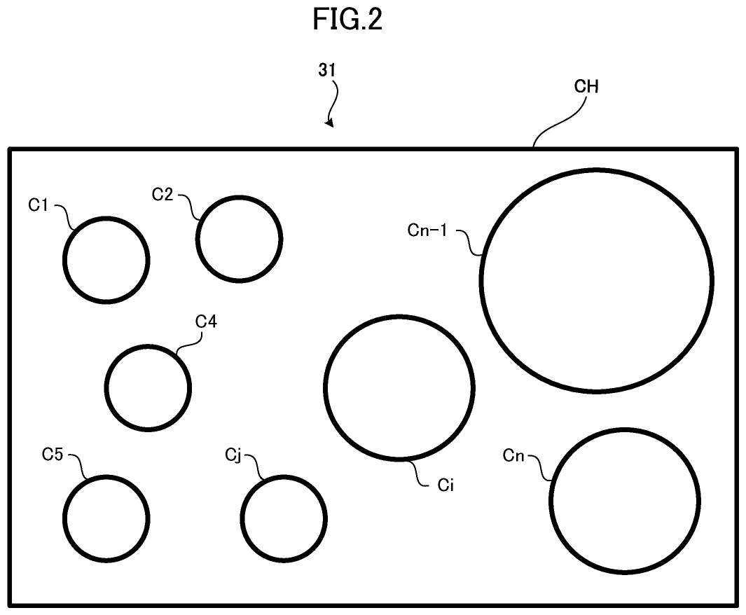

FIG. 2 is a diagram illustrating an example of content of the new design data 31. As illustrated in FIG. 2, the new design data 31 includes data indicating a semiconductor chip CH, two-dimensional images of n circuit elements C₁ to Cₙ disposed on the semiconductor chip CH, and positions of these circuit elements C₁ to Cₙ. Here, n is an integer equal to or greater than 2; in a case illustrated in FIG. 2, n=8, and i and j are natural numbers different from each other in a range of at least 1 but not more than n. The description assumes that the circuit elements C₁ to Cₙ have circular shapes.

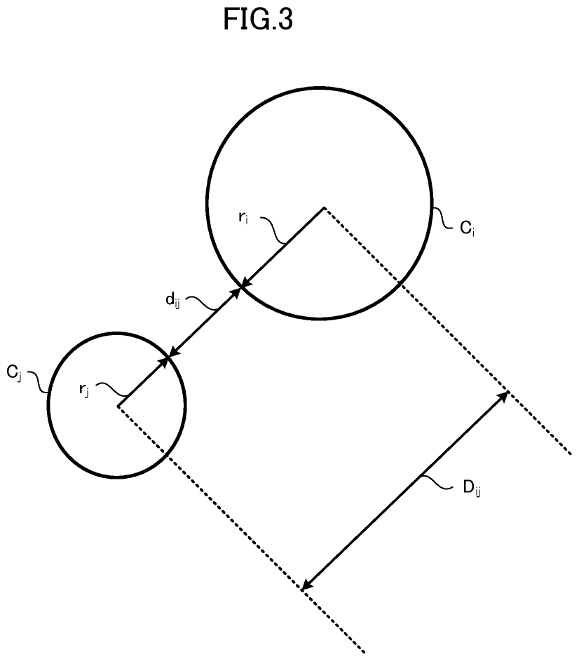

FIG. 3 is a diagram illustrating radii rᵢ and rⱼ of the circuit elements Cᵢ and Cⱼ, a circuit element distance Dᵢⱼ defined as a distance between the centers of the circuit elements Cᵢ and Cⱼ, and an outline distance dᵢⱼ that is a distance between the outlines of the circuit elements Cᵢ and Cⱼ. The circuit element distance Dᵢⱼ, the radii rᵢ and rⱼ, and the outline distance dᵢⱼ satisfy a relationship: dᵢⱼ=Dᵢⱼ−rᵢ−rⱼ. The relationships of the circuit element distance Dᵢⱼ=Dⱼᵢ and the outline distance dᵢⱼ=dⱼᵢ are also established. The following description is given assuming that the outline distance dᵢⱼ is a variable defining the design constraint, that is, a design variable. The design variable is a variable included in the design data, for determining whether the design data satisfies the design constraint.

In the present embodiment, a relationship of “outline distance dᵢⱼ≥reference distance dₜₕᵢⱼ” is set as the first design constraint. That is, it is set that the circuit elements Cᵢ and Cⱼ are to be disposed spaced apart from each other by the reference distance dₜₕᵢⱼ or more. Also, this design support system 1 finds a threshold dᵣₜₕᵢⱼ that determines a pass even when the outline distance dᵢⱼ of the circuit elements Cᵢ and Cⱼ is less than the reference distance dₜₕᵢⱼ, and determines a pass when the outline distance dᵢⱼ is equal to or greater than the threshold dᵣₜₕᵢⱼ.

The UI device 10 illustrated in FIG. 1 has a display device that displays an image to present the image to an operator, a keyboard that receives an operation by the operator, and a data input/output terminal such as a mouse, a tablet device, and a USB terminal.

The threshold calculation device 20 includes a design reference database (DB) 21 that stores the first design constraint, a past design DB 22 that stores the design data having already been verified for product shipment, a threshold calculator 23 that calculates the threshold dᵣₜₕᵢⱼ of the outline distance dᵢⱼ corresponding to the relaxed design constraint, and a threshold DB 24 that stores the calculated threshold dᵣₜₕᵢⱼ.

The design reference DB 21 stores the design constraint set by a designer, that is the first design constraint. As described above, in the present embodiment, the design constraint includes the reference distance dₜₕᵢⱼ of the outline distance dᵢⱼ between the circuit elements Cᵢ and Cⱼ. When the outline distance d between the circuit elements Cᵢ and Cⱼ is equal to or greater than the reference distance dₜₕᵢⱼ, the outline distance dᵢⱼ satisfies the first design constraint. The reference distance dₜₕᵢⱼ is a value common to a plurality of designs. The design reference DB 21 serves as a design reference storage. The reference distance dₜₕᵢⱼ is an example of the first design constraint value.

The past design DB 22 stores the verified design data. Here, the verified design data is past design data having already been verified for product shipment. The past design DB 22 stores, as the verified design data, the design data determined as a “pass” in the past verification, that is, the design data for which no substantial problem is verified and commercialization is reached. Whether or not the design data is given a “pass” is determined based on results of a variety of performance evaluation tests on a prototype of a product obtained based on the design data.

The threshold calculator 23 finds the second design constraint based on the past design data stored in the past design DB 22. In this example, the threshold dᵣₜₕᵢⱼ for the outline distance dᵢⱼ between the circuit elements Cᵢ and Cⱼ is found. The threshold dᵣₜₕᵢⱼ is a minimum value of the outline distance that is smaller than the reference distance dₜₕᵢⱼ but could be given a pass. A way of finding the threshold dᵣₜₕᵢⱼ is described later. The threshold DB 24 stores the threshold dᵣₜₕᵢⱼ calculated by the threshold calculator 23. The threshold dᵣₜₕᵢⱼ is an example of a second design constraint value.

The threshold calculator 23 additionally stores the calculated threshold dᵣₜₕᵢⱼ when the calculated threshold dᵣₜₕᵢⱼ does not exist in the threshold DB 24, and replaces the existing threshold dᵣₜₕᵢⱼ with a newly calculated threshold dᵣₜₕᵢⱼ when the calculated threshold dᵣₜₕᵢⱼ already exists in the threshold DB 24.

The new design data 31 is created by the CAD device 40 and supplied through a network to this design support system 1. As illustrated in the example of FIGS. 2 and 3, the new design data 31 is data that defines shapes, sizes, positions, and the like of the circuit elements of the semiconductor device to be designed. As for the outline distance, the design verification device 30 reads the reference distance dₜₕᵢⱼ from the design reference DB 21 and reads the threshold dᵣₜₕᵢⱼ from the threshold DB 24.

The design verification device 30 finds the outline distance dᵢⱼ and the reference distance dₜₕᵢⱼ for all combinations of adjoining circuit elements Cᵢ and Cⱼ included in the new design data 31. The design verification device 30 compares the found outline distance dᵢⱼ with the reference distance dₜₕᵢⱼ, and determines the design choices as given a pass since the first design constraint is satisfied when the outline distance dᵢⱼ≥the reference distance dₜₕᵢⱼ.

Also, when the outer distance dᵢⱼ<the reference distance dₜₕᵢⱼ, the design verification device 30 compares the outline distance dᵢⱼ with the threshold dᵣₜₕᵢⱼ, and determines the design choices as given a pass since the first design constraint is not satisfied but the second design constraint is satisfied when the outline distance dᵢⱼ≥the threshold dᵣₜₕᵢⱼ.

Also, when the outline distance dᵢⱼ<the threshold dᵣₜₕᵢⱼ≤the reference distance dₜₕᵢⱼ, the design verification device 30 determines the design choices as given a fail since the outline distance dᵢⱼ is too small to satisfy the first design constraint and the second design constraint.

The design verification device 30 writes the result of verification into a verification result output file 32. The design verification device 30 outputs the verification result output file 32 upon completion of verification about all the combinations of the adjoining circuit elements Cᵢ and Cⱼ.

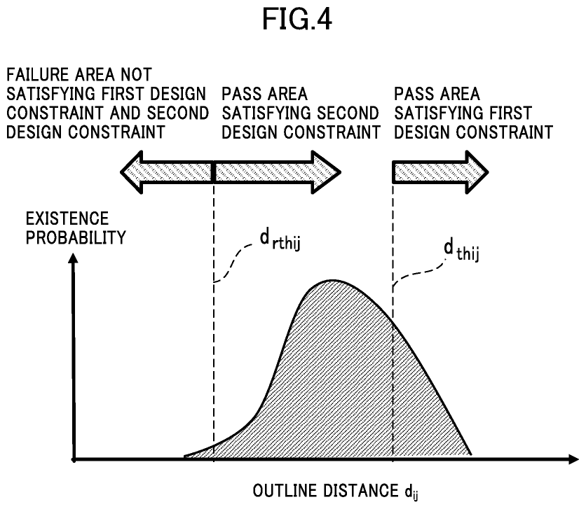

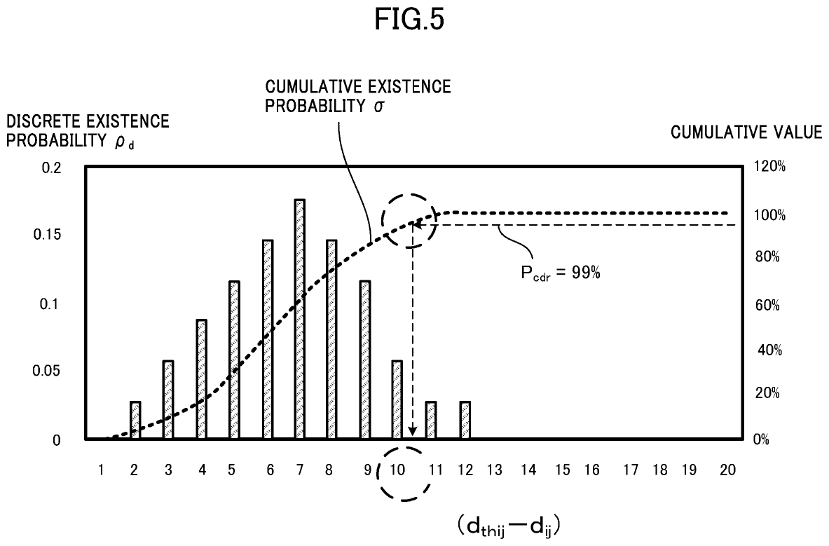

Next, a procedure of finding the second design constraint, more precisely, the threshold dᵣₜₕᵢⱼ is described with reference to FIGS. 4 and 5. The threshold calculator 23 sets the threshold dᵣₜₕᵢⱼ that is a value indicating the second design constraint by analyzing, using statistical processing, the frequency distribution of the outline distance dᵢⱼ that is a design variable.

The threshold calculator 23 first finds all the combinations of two circuit elements Cᵢ and Cⱼ that can be determined as adjoining among n circuit elements C₁ to Cₙ indicated by the design data stored in the past design DB 22. In the example of FIG. 2, the threshold calculator 23 finds, for example, a group of circuit elements [(C₁, C₂), (C₃, C₄), . . . , (Cᵢ, Cⱼ), . . . (Cₙ₋₁, Cₙ)].

Next, the threshold calculator 23 extracts the outline distance dᵢⱼ for each of the combinations of the circuit elements Cᵢ, Cⱼ included in the group of circuit elements [(C₁, C₂), (C₃, C₄), . . . , (Cᵢ, Cⱼ), . . . (Cₙ₋₁, Cₙ)]. The extracted outline distance dᵢⱼ is distributed, for example, as illustrated in FIG. 4.

The threshold calculator 23 reads from the design reference DB 21 the reference distance dₜₕᵢⱼ for each combination of i and j.

Next, the threshold calculator 23 extracts, from the extracted outline distance dᵢⱼ, only an outline distance dᵢⱼ that is less than the reference distance dₜₕᵢⱼ. The extracted outline distance dᵢⱼ is a value that does not satisfy the first design constraint but is determined as normal as an overall semiconductor device leading to commercialization. The outline distance dᵢⱼ is thus a value for which a significant problem would not occur even if the outline distance dᵢⱼ is used as such a value.

Next, as illustrated in FIG. 5, the threshold calculator 23 creates a graph letting [the reference distance dₜₕᵢⱼ—the outline distance dᵢⱼ] be the horizontal axis and the discrete existence probability ρ_{d} be the vertical axis for the extracted outline distance dᵢⱼ. The threshold calculator 23 further finds the cumulative existence probability σ indicating a cumulative value of the discrete existence probability pd.

FIG. 5 illustrates the discrete existence probability ρ_{d} and the cumulative existence probability σ indicating probabilities that [the reference distance dₜₕᵢⱼ−the outline distance dᵢⱼ] exists in each of the sections into which [the reference distance dₜₕᵢⱼ−the outline distance dᵢⱼ] is divided. In FIG. 5, to facilitate understating of distribution of the discrete existence probability ρ_{d}, the discrete existence probability ρ_{d} is expressed in graph form for each section of [the reference distance dₜₕᵢⱼ−the outline distance dᵢⱼ]. FIG. 5 does not necessarily correspond to FIG. 4.

Since the actual existence probability ρ_{d} is continuous, the cumulative existence probability σ is indicated by a continuous dotted line to conform to the distribution of the actual existence probability ρ_{d}. In other words, the threshold calculator 23 statistically processes the outline distance dᵢⱼ included in the past design data, and as illustrated in FIG. 5, calculates the discrete existence probability ρ_{d} and its cumulative existence probability σ in each of the sections of [the reference distance dₜₕᵢⱼ−the outline distance dᵢⱼ].

The threshold calculator 23 finds the outline distance dᵢⱼ that corresponds to a portion of the cumulative existence probability σ reaching a predetermined setting value P_{cdr}, for example, 99%, of the design support system 1. The setting value P_{cdr} is specified appropriately, for example, by a manufacturer or an operator using the UI device 10. The threshold calculator 23 sets the found outline distance dᵢⱼ as the threshold dᵣₜₕᵢⱼ. In FIG. 5, the sections up to the 10th section of [the reference distance dₜₕᵢⱼ−the outline distance dᵢⱼ] is the maximum sections in a range where the cumulative existence probability a does not exceed the predetermined setting value P_{cdr}, for example, 99%. Thus the threshold calculator 23 sets as the design threshold dᵣₜₕᵢⱼ the outline distance dᵢⱼ corresponding to this point in the 10th section.

When the found threshold dᵣₜₕᵢⱼ is less than the previous design threshold dᵣₜₕᵢⱼ stored in the threshold DB 24, the threshold calculator 23 stores the found threshold d as a new design threshold dᵣₜₕᵢⱼ, and updates the threshold file. When the design threshold dᵣₜₕᵢⱼ of the combination of the circuit elements Cᵢ and Cⱼ is not stored in the threshold DB 24, the threshold calculator 23 newly stores the found design threshold dᵣₜₕᵢⱼ as the threshold dᵣₜₕᵢⱼ of the combination of the circuit elements Cᵢ and Cⱼ, and updates the threshold file.

In this way, the threshold calculator 23 serves as variable extraction means for extracting, from the plurality of verified design data for which commercialization is reached, the variable dᵢⱼ that defines the design constraint, existence probability acquisition means for finding the existence probability ρ_{d} of the extracted variable dᵢⱼ, cumulative existence probability acquisition means for finding the cumulative existence probability σ of the found existence probability ρ_{d}, and setting means for identifying a value of the variable dᵢⱼ that is a value when the cumulative existence probability σ matches the preset reference value P_{cdr} and setting the identified value to the design constraint value. The outline reference distance dₜₕᵢⱼ and the design threshold dᵣₜₕᵢⱼ are examples of the design constraint value.

Next, operation of the design support system 1 is described.

A user operates the UI 10 and stores in the past design DB 22 the past design data that has been verified and reached commercialization.

The user acquires the new design data 31 to be verified. The user also acquires in the design reference DB 21 the design constraint of the new design data 31 to be verified.

Also, the user specifies the setting value P_{cdr} and the number n of the circuit elements included in the new design data 31, for example, using the UI device 10.

Next, the user instructs uses the UI device 10 to send an instruction for verification of the new design data 31.

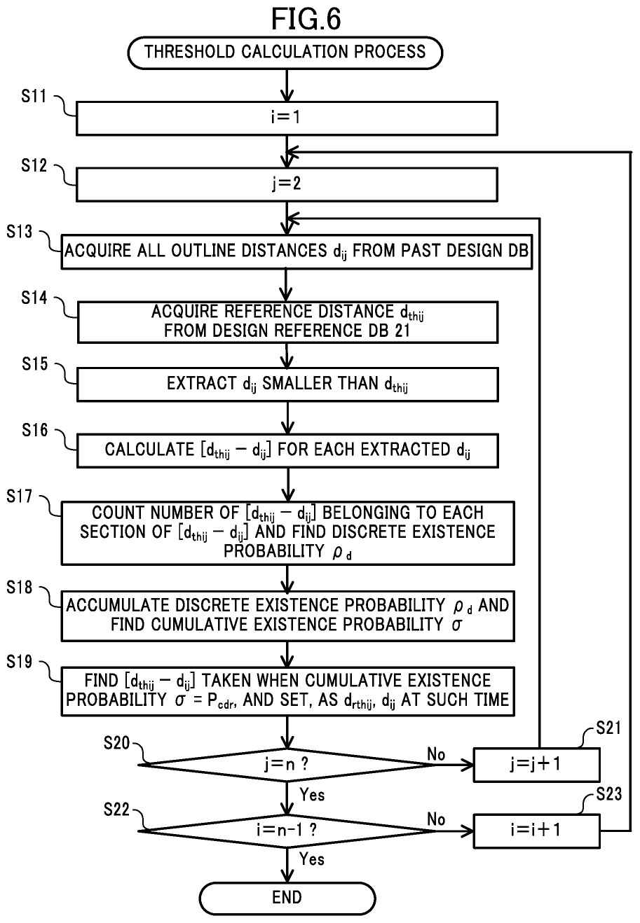

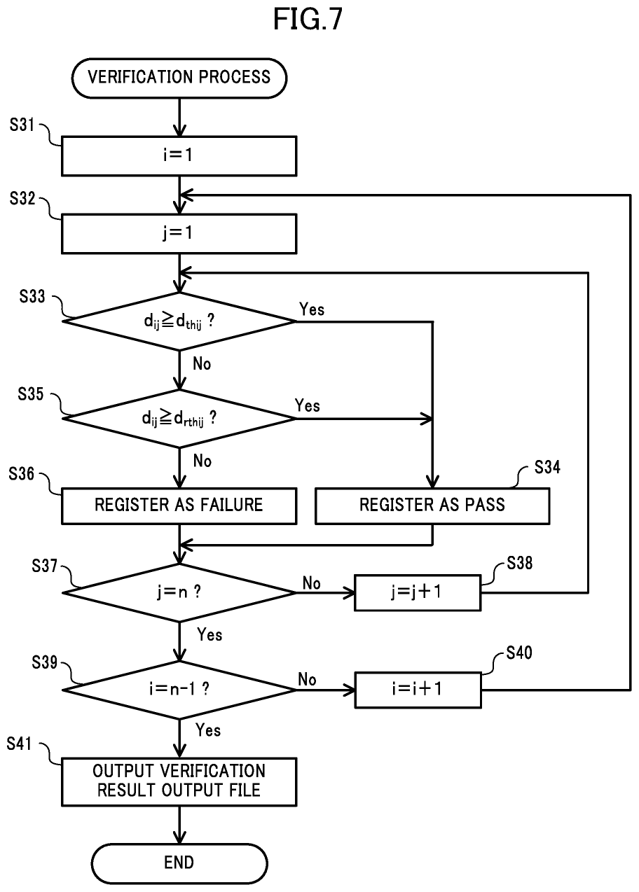

In response to this instruction, the design support system 1 executes a threshold calculation process illustrated in FIG. 6 and then a verification process illustrated in FIG. 7.

The threshold calculation process and the verification process are described hereinafter with reference to FIGS. 6 and 7.

First, upon start of the threshold calculation process illustrated in FIG. 6, the threshold calculator 23 sets to 1 the variables i and j (steps S11 and S12).

Next, the threshold calculator 23 retrieves from the past design DB 22 the outline distance dᵢⱼ between the circuit elements Cᵢ and Cⱼ of the circuit designed in the past (step S13). The threshold calculator 23 also retrieves from the design reference DB 21 the reference distance dₜₕᵢⱼ of the outline distance between the circuit elements Cᵢ and Cⱼ (step S14).

Next, among the extracted outline distances dᵢⱼ, an outline distance dᵢⱼ that is less than the reference distance dₜₕᵢⱼ is extracted (step S15). The threshold calculator 23 calculates [the reference distance dₜₕᵢⱼ−the outline distance dᵢⱼ] for the extracted outline distance dᵢⱼ (step S16).

Next, the threshold calculator 23 divides a range of possible values of the calculated [the reference distance dₜₕᵢⱼ−the outline distance dᵢⱼ] into sections. Then the threshold calculator 23 counts the number of [the reference distance dₜₕᵢⱼ−the outline distance dᵢⱼ] that exists in each of the sections, and as illustrated in FIG. 5, finds the discrete existence probability ρ_{d} that indicates a probability relative to the whole (step S17).

The threshold calculator 23 accumulates the discrete existence probability ρ_{d} and finds the cumulative existence probability σ (step S18).

The threshold calculator 23 finds [the reference distance dₜₕᵢⱼ−the outline distance dᵢⱼ] where the cumulative existence probability a matches the setting value P_{cdr} (step S19). Next, the threshold calculator 23 finds the outline distance dᵢⱼ from the found value of [the reference distance dₜₕᵢⱼ−the outline distance dᵢⱼ] and the reference distance dₜₕᵢⱼ, and sets the found outline distance dᵢⱼ as the threshold dᵣₜₕᵢⱼ, and registers this result in the threshold DB 24 (step S19).

Next, the threshold calculator 23 determines whether or not the variable j reaches n (step S20), and when the valuable j does not reach n, the threshold calculator 23 performs j=j+1 (step S21), and then the process goes to step S13 to continue. Here, the outline distance dᵢⱼ between the circuit elements Cᵢ and Cⱼ is equal to the outline distance between the circuit elements Cⱼ and Cᵢ. That is, dᵢⱼ=dⱼᵢ. Thus, when updating, the variable j is updated so as not to perform processing with respect to the processed dᵢⱼ again.

When determination is made in step S20 that j=n (Yes in step S20), the threshold calculator 23 determines whether or not the variable i reaches n−1 (step S22). When determination is made that the variable i does not reach n−1 (No in step S22), the threshold calculator 23 performs i=i+1 (step S21), and the process goes to step S12 to continue. As described above, dᵢⱼ=dⱼᵢ. Thus, when updated, the variable i is updated so as not to perform processing with respect to the processed dᵢⱼ or not to be equal to the variable j.

In this way, determination is made in step S22 that j=n−1 after the outline distances d₁₂, d₁₃, . . . , d₁ₙ, d₂₃, d₂₄, . . . , d₂ₙ, d₃₄, d₃₅, . . . , and d_{n-1,n}, and then the process goes to the verification process of FIG. 7.

Upon start of the verification process, the design verification device 30 first sets to 1 the variables i and j (steps S31 and S32).

Next, the threshold calculator 23 determines whether or not the outline distance dᵢⱼ satisfies the first design constraint registered in the design reference DB 21, that is, whether or not the outline distance dᵢⱼ≥the reference distance dₜₕᵢⱼ (step S33). When determination is made that the outline distance dᵢⱼ satisfies the first design constraint, that is, the outline distance dᵢⱼ≥the reference distance dₜₕᵢⱼ (Yes in step S33), the design verification device 30 determines that the design item is given a pass, and registers the verification result in the verification result output file 32 (step S34).

When determination is made that the outline distance dᵢⱼ does not satisfy the first design constraint, that is, the outline distance dᵢⱼ<the reference distance dₜₕᵢⱼ (No in step S33), the design verification device 30 determines whether or not the outline distance dᵢⱼ satisfies the second design constraint registered in the threshold DB 24, that is, the outline distance dᵢⱼ≥the threshold dᵣₜₕᵢⱼ (step S35). When determination is made that the outline distance dᵢⱼ satisfies the second design constraint, that is, the outline distance dᵢⱼ≥the threshold dᵣₜₕᵢⱼ (Yes in step S35), the design verification device 30 determines that the design item is given a pass, and registers the verification result in the verification result output file 32 (step S34).

When determination is made that the outline distance dᵢⱼ does not satisfy the second design constraint, that is, the outline distance dᵢⱼ<the threshold dᵣₜₕᵢⱼ (No in step S35), the design verification device 30 determines that the design item is given a fail, and registers the verification result in the verification result output file 32 (step S36).

When determination is made in step S37 that j=n (Yes in step S37), the design verification device 30 determines whether or not the variable j reaches n (step S38), and when determination is made that j=n is not satisfied, the design verification device 30 performs j=j+1 (step S38), and then the process goes to step S33 to continue. As described above, dᵢⱼ=dⱼᵢ. Thus, when updated, the variable j is updated so as not to perform processing on the processed dᵢⱼ again, or for i not to be equal to j.

When determination is made in step S38 that j=n is satisfied (Yes in step S38), the design verification device 30 determines whether or not the variable i reaches n−1 (step S39), and when determination is made that i=n−1 is not satisfied, the design verification device 30 performs i=i+1 (step S40), and then the process goes to step S32 to continue. As described above, dᵢⱼ=dⱼᵢ. Thus, when updated, the variable i is updated so as not to perform processing on the processed dᵢⱼ again.

In this way, verification on the outline distances d₁₂, d₁₃, . . . , d₁ₙ, d₂₃, d₂₄, . . . , d₂ₙ, d₃₄, d₃₅, . . . , and d_{n-1, n}, is performed in order.

Eventually, the design verification device 30 outputs the verification result output file 32 (step S41) and the process ends.

As described above, the threshold calculation device 20 according to the present embodiment extracts as the design variable the outline distance dᵢⱼ from the verified design data, and sets the threshold dᵣₜₕᵢⱼ that is a value indicating the second design constraint by analyzing, using statistical processing, the frequency distribution of the extracted outline distance dᵢⱼ. This enables automatic finding of the second design constraint, that is, the threshold, that are economical and reasonable in a range where the final performance of the design target is expected to achieve the goal. This enables easy acquisition of the second design constraint that is a properly relaxed design constraint with less dependence on an individual user. Thus the economical and reasonable design constraint for which the performance of the design product, such as electric performance, does not exceed the target value excessively can be generated easily.

In the above embodiment, the threshold is found from the design data for which pass/fail determination has been performed. Thus, occurrence of a pseudo-error corresponding to an error different from pass/fail determination made by the designer distance can be prevented at checking of the design constraint. More specifically, such pseudo-error is likely to occur when the outline distance dᵢⱼ is in a range between the design constraint value dₜₕᵢⱼ and the design threshold dᵣₜₕᵢⱼ, or when a difference between the design constraint value dₜₕᵢⱼ and the design threshold dᵣₜₕᵢⱼ is great. In the design support system 1, since all of the individual outline distances dᵢⱼ are compared with the design threshold dᵣₜₕᵢⱼ corresponding to this outline distance dᵢⱼ, a pseudo-error in check such as that occurring in a visual check of the design drawing would not occur.

Thus, according to the design support system 1, circuit elements or the like that are components included in a device can be disposed properly. This results enables reduction in size of the device, such as a size of the semiconductor chip CH, and enables economical manufacture of the device.

In the above embodiment, the present disclosure is described using an example of the design constraint that “the outline distance d is equal to or greater than the reference distance dₜₕ”. The present disclosure is not limited thereto. For example, the design constraint that “the outline distance d is equal to or less than the reference distance dₜₕ” can be applied similarly.

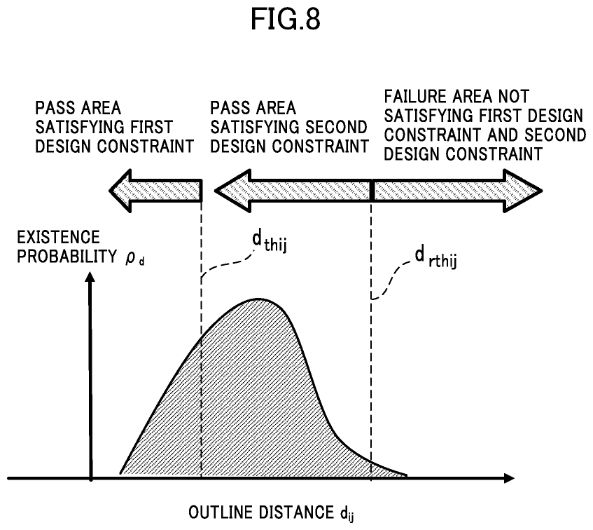

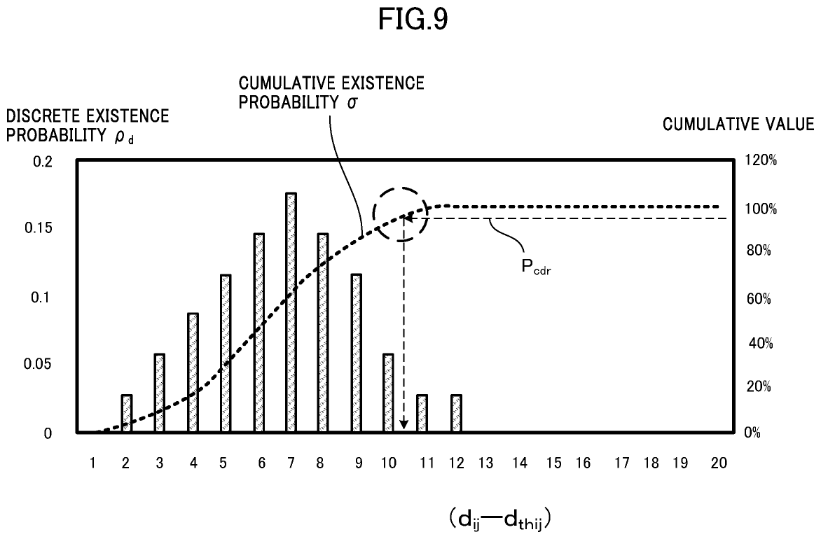

In this case, as illustrated in the example of FIGS. 8 and 9, “outline distance dᵢⱼ≥reference distance dₜₕᵢⱼ” and the discrete existence probability ρ_{d} and the cumulative existence probability σ are found for the outline distance dᵢⱼ that is greater than the reference distance dₜₕᵢⱼ. Then the outline distance dᵢⱼ when the cumulative existence probability σ matches the reference value P_{cdr} is set as the threshold dᵣₜₕᵢⱼ.

Thus, as illustrated in FIG. 8, when the outer distance dᵢⱼ≤the reference distance dₜₕᵢⱼ, the design choices satisfy the first design constraint, thus resulting in a pass. When the reference distance dₜₕᵢⱼ<the outline distance dᵢⱼ≤the threshold value dᵣₜₕᵢⱼ, the design choices do not satisfy the first design constraint but satisfy the second design constraint, thus resulting in a pass. When the threshold dᵣₜₕᵢⱼ<the outline distance dᵢⱼ, the design choices do not satisfy the first design constraint and the second design constraint, thus resulting in a fail.

In the present embodiment, the “outline distance” is used as an example of the variable defining the design constraint. The present embodiment can be applied similarly as for any other variables, for example, a design constraint such as an intercomponent distance D, a radius r, or the like. Also, although the present disclosure is described using the circuit elements of the semiconductor device as an example, the present embodiment can also be applied similarly to circuit elements of any electric and electronic circuits and mechanical elements of machines. The same applies to embodiments described later.

In the present embodiment, to facilitate understanding, a difference between the variable value and the design reference value is found and the discrete existence probability and the cumulative existence probability are found to find the existence probability and the cumulative existence probability of the variable that does not satisfy the first design constraint. The present disclosure is not limited this method. A method for extracting a variable for which determination is made that the variable does not satisfy the first design constraint but is given a pass as a whole, and finding the existence probability and the cumulative existence probability of the extracted variable is freely selected. For example, the extracted variable maybe processed directly without taking the difference. The same applies to embodiments described later.

### Embodiment 2

The present disclosure is described in Embodiment 1 using as an example the design constraint that the variable value is equal to or greater than the reference value or equal to or less than the reference threshold.

The present disclosure is not limited to thereto. For example, the design constraint may be given in the form of the constraint that “an equation having a plurality of variables is satisfied”. A process in such a case is described as Embodiment 2.

The configuration of the design support system according to the present disclosure is the same as the configuration of the design support system 1 of Embodiment 1 illustrated in FIG. 1. The design data is described under the assumption of being identical to the design data illustrated in FIGS. 2 and 3.

Here, the design constraint is assumed to be the constraint that “dᵢⱼ=Dᵢⱼ−(rᵢ+rⱼ) is satisfied” as illustrated with reference to FIG. 3. Also, each variable is assumed to have a specified individual design constraint that the variable is equal to or greater than the reference value.

In this case, the threshold calculator 23 specifies the circuit element distance Dᵢⱼ, the radius rᵢ, the radius rⱼ, and the outline distance dᵢⱼ as variables of the equation defining the design constraint.

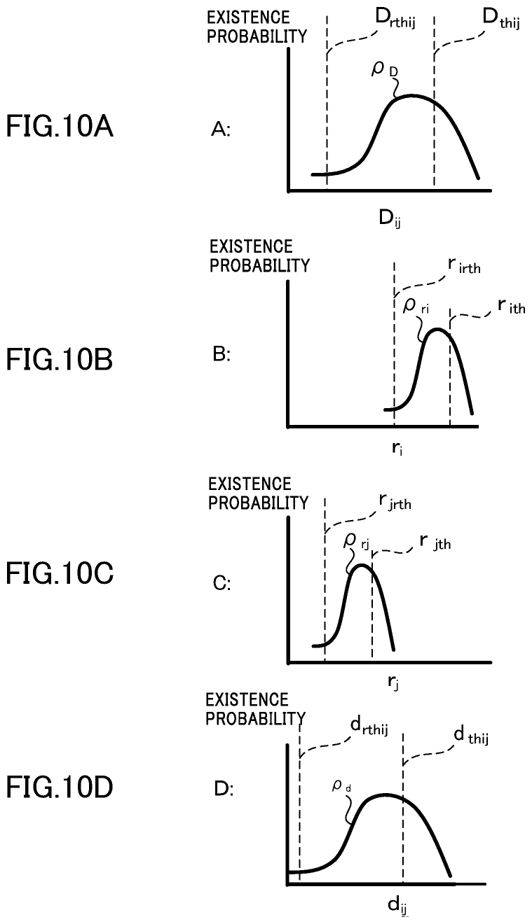

These variables indicate distributions, for example, as illustrated in the examples of FIGS. 10A to 10D.

In the present embodiment, as illustrated in FIG. 10A, determination is made that the circuit element distance Dᵢⱼ is given a pass as satisfying the first design constraint when the circuit element distance Dᵢⱼ≥the reference value Dₜₕᵢⱼ, the circuit element distance Dᵢⱼ is given a pass as satisfying the second design constraint when the reference value Dₜₕᵢⱼ>the circuit element distance Dᵢⱼ≥the threshold value Dᵣₜₕᵢⱼ, and the circuit element distance Dᵢⱼ is given a fail when the threshold Dₜₕᵢⱼ>the circuit element distance Dᵢⱼ.

Also, as illustrated in FIG. 10B, determination is made that the radius r is given a pass as satisfying the first design constraint when the radius rᵢ≥the reference value, the radius rᵢ is given a pass as satisfying the second design constraint when the reference value rₜₕᵢ>the radium rᵢ≥the threshold rₜₕᵢ, and the radius rᵢ is given a fail when the threshold rₜₕᵢ>the radius rᵢ.

Similarly, as illustrated in FIG. 10C, determination is made that the radius rⱼ is given a pass as satisfying the first design constraint when the radius rⱼ≥the reference value rₜₕⱼ, the radius rᵢ is given a pass as satisfying the second design constraint when the reference value rₜₕⱼ>the radius rᵢ≥the threshold rₜₕⱼ, and the radius rⱼ is given a fail when the threshold rₜₕⱼ>the radius rⱼ.

As illustrated in FIG. 10D, determination is made that the outline distance dᵢⱼ is given a pass as satisfying the first design constraint when the outline distance dᵢⱼ≥the reference value dₜₕᵢⱼ, the outline distance dᵢⱼ is given a pass as satisfying the second design constraint when the reference value dₜₕᵢⱼ>the outline distance dᵢⱼ≥the threshold dₜₕᵢⱼ, and the outline distance dᵢⱼ is given a fail as satisfying the second design constraint when the threshold Dᵣₜₕᵢⱼ>the circuit element distance Dᵢⱼ.

To find the threshold Dᵣₜₕᵢⱼ of the circuit element distance Dᵢⱼ, the threshold calculator 23 i) processes the design data stored in the past design DB 22 and extracts the circuit element distance Dᵢⱼ that is (the reference value Dₜₕᵢⱼ>the circuit element distance Dᵢⱼ), ii) finds the discrete existence probability ρ_{D} of (the reference value Dₜₕᵢⱼ>the circuit element distance Dᵢⱼ), iii) accumulates the discrete existence probability ρ_{D} and finds a curve of the cumulative existence probability σ_{D}, and iv) sets, as the threshold Dᵣₜₕᵢⱼ of the circuit element distance, the circuit element distance Dᵢⱼ that is a distance taken when the cumulative existence probability σ_{D} equals a predetermined value P_{Dcdr}, and stores the threshold Dᵣₜₕᵢⱼ in the threshold DB 24.

To find the threshold rᵣᵢ of the radius ri, the threshold calculator 23 i) processes the design data stored in the past design DB 22 and extracts the radius rᵢ that is (the reference value rₜₕᵣᵢ>the radius rᵢ), ii) finds the discrete existence probability ρᵣᵢ of (the reference value rₜᵢ−the radius rᵢ), iii) accumulates the discrete existence probability ρᵣᵢ and finds a curve of the cumulative existence probability σᵣᵢ, and iv) sets, as the threshold rᵢ of the radius rᵢ, the radius rᵢ that is a radius taken when the cumulative existence probability σᵣᵢ equals a predetermined value P_{ricdr}, and stores the threshold rᵣᵢ in the threshold DB 24.

Similarly, to find the threshold rᵣⱼ of the radius rⱼ, the threshold calculator 23 i) processes the design data stored in the past design DB 22 and extracts the radius rⱼ that is (the reference value rₜₕᵣⱼ>the radius rⱼ), ii) finds the discrete existence probability ρᵣⱼ of (the reference value rᵣⱼ−the radius rⱼ), iii) accumulates the discrete existence probability ρᵣⱼ and finds a curve of the cumulative existence probability σᵣⱼ, and iii) sets, as the threshold rᵣⱼ of the radius rⱼ, the radius rⱼ that is a radius taken when the cumulative existence probability σᵣⱼ equals a predetermined value P_{rjcdr}, and stores the threshold rᵣⱼ in the threshold DB 24.

The process for threshold calculator 23 to find the threshold dᵣᵢⱼ of the outline distance dᵢⱼ is similar to that of Embodiment 1.

However, the values of integrals ∫ρ_{D}, ∫ρᵣᵢ, ∫ρᵣⱼ, and ∫ρ_{d} over a range of the respective existence probability ρ_{D}, ρᵣᵢ, ρᵣⱼ, and ρ_{d} are each calculated to be equal to 1. That is, ∫ρ_{D}=∫ρᵣᵢ=∫ρᵣⱼ=∫ρ_{d}=1.

The design verification device 30 i) determines that the circuit element distance Dᵢⱼ satisfies the design constraint when the circuit element distance Dᵢⱼ≥the threshold Dᵣₜₕᵢⱼ, ii) determines that the radius rᵢ satisfies the design constraint when the radius rᵢ≥the threshold rᵣᵢ, iii) determines that the radius rⱼ satisfies the design constraint when the radius rⱼ≥the threshold rᵣⱼ, and iv) determines that the outline distance dᵢⱼ satisfies the design constraint when the outline distance dᵢⱼ≥the threshold dᵣₜₕᵢⱼ.

### Embodiment 3

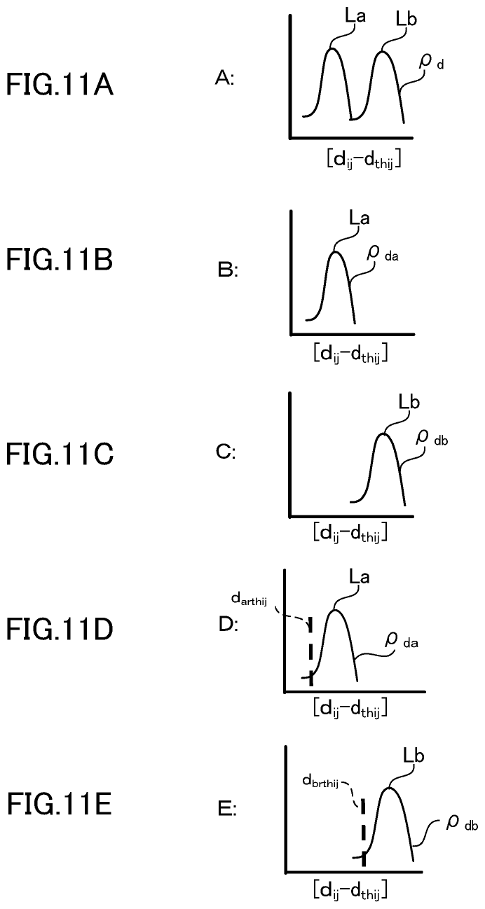

Embodiment 3 of the present disclosure is described hereinafter with reference to FIGS. 11A-11E that illustrate a process in a design support system 1 according to the present embodiment. The configuration of the design support system of Embodiment 3 is identical to the configuration of the design support system 1 of Embodiment 1. Also, in the present embodiment, the first design constraint is described assuming that the outline distance dᵢⱼ≥the reference value dₜₕᵢⱼ.

FIG. 11A illustrates a case where the existence probability ρ_{d} of [the reference value dₜₕᵢⱼ−the outline distance dᵢⱼ] of the circuit elements Cᵢ and Cⱼ included in the past design data includes a plurality of extreme values, for example, two maximum values La and Lb. FIGS. 11B and 11C illustrate parts ρ_{da} and ρ_{db} obtained by separating the curve indicating the existence probability ρ_{d} illustrated in FIG. 11A, and the parts ρ_{da} and ρ_{db} include respectively of the maximum values La and Lb. FIGS. 11D and 11E illustrate thresholds dₐᵣₜₕᵢⱼ and d_{brthij} obtained from the existence probabilities ρ_{da} and ρ_{db} illustrated in FIGS. 11B and 11C.

As illustrated in FIG. 11A, a plurality of maximum values, for example, two maximum values La and Lb may generate in the existence probability ρ_{d} of the circuit elements Cᵢ and Cⱼ included in the past design data. For example, such maximum values may occur in a case where the circuit elements Cᵢ and Cⱼ are used in common in the semiconductor device enclosed in a plurality of forms of semiconductor device packages each having a specific attribute. Examples of the semiconductor device packages having shapes with such attributes include a small outline package (SOP) and a ball grid array (BGA).

The maximum value for each attribute of the package can be obtained by the threshold calculator 23 statistically analyzing the distribution of the existence probability ρ_{d} of [dₜₕᵢⱼ−dᵢⱼ] of the circuit elements Cᵢ and Cⱼ in the design data stored in the past design DB 22. The threshold calculator 23 can find, by such statistical analysis of the distribution of the existence probability ρ_{d}, the attribute of the semiconductor device package or the like indicated by each of the maximum values La and Lb illustrated in FIG. 11A.

In this case, the threshold calculator 23 determines whether or not the plurality of maximum values exist in the existence probability ρ_{d} of [dₜₕᵢⱼ−dᵢⱼ] of the circuit elements Cᵢ and Cⱼ indicated by the design data stored in the past design DB 22. When the existence probability ρ_{d} has two maximum values La and Lb as illustrated in FIG. 11A, the threshold calculator 23 separates the curve of the existence probability ρ_{d} into a partial curve ρ_{da} including the maximum value La illustrated in FIG. 11B and a partial curve ρ_{db} including the maximum value Lb illustrated in FIG. 11C.

Then, the threshold calculator 23 sets, as the threshold dₐᵣₜₕᵢⱼ, the outline distance dᵢⱼ providing the cumulative existence probability σ equal to a predetermined value P_{cdr}, only for the partial curve ρ_{da} including the maximum value La. The threshold calculator 23 also sets, as the threshold d_{brthij}, the outline distance dᵢⱼ providing the cumulative existence probability a equal to the predetermined value P_{cdr}, only for the partial curve ρ_{db} including the maximum value Lb.

When the existence probability ρ_{d} has three or more maximum values, the threshold calculator 23 performs similar processing on each partial curve including a maximum value and obtains the thresholds dₐᵣₜₕᵢⱼ, d_{brthij}, d_{crthij}, . . . . The threshold calculator 23 outputs to the verification result output file 32 the thresholds dₐᵣₜₕᵢⱼ, d_{brthij}, d_{crthij}, . . . obtained by the above-described processing. The predetermined value P_{cdr} may be a value common in the plurality of partial curves of the cumulative existence probability a or may be different values for different partial curves.

The design support system 1 according to Embodiment 3 enables verification, for each attribute such as a semiconductor device or the like, of whether the outline distance dᵢⱼ between the circuit elements Cᵢ and Cⱼ is appropriate, and can improve accuracy of the verification result indicated by the verification result output file 32.

### Embodiment 4

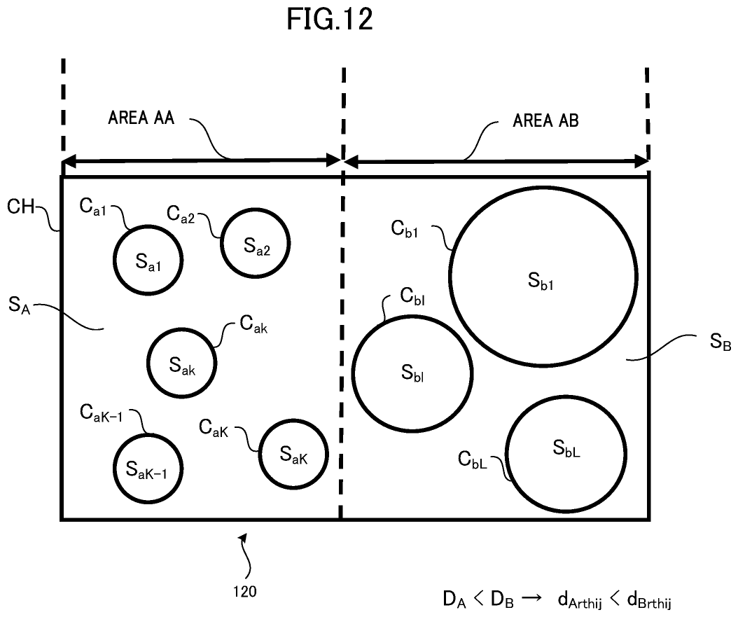

Embodiment 4 of the present disclosure is described hereinafter with reference to FIG. 12 that illustrates a process in a design support system 1 according to the present embodiment.

FIG. 12 is a drawing illustrating content of new design data 31. The new design data 31 includes data illustrating a two-dimensional image of a semiconductor chip CH of a semiconductor device to be processed in the design support system 1 and two types of circuit elements Cₐₗ to Cₐₖ and C_{bl} to C_{bL} disposed on the semiconductor chip CH. In FIG. 12, K=5 and L=3, where k is any number of at least 1 but not more than k, and l is any number that is at least 1 but no more than L.

Since the semiconductor device has different sizes, densities, or the like of the circuit elements, the semiconductor device may be designed by separation into areas AA and AB that can be indicated by closed figures. For example, in the semiconductor device illustrated in FIG. 12, in the area AA, for example, a digital circuit is disposed, and in the area AB, an analog circuit is disposed.

The design verification device 30 calculates an area share D_{A} of the circuit elements Cₐₗ to C_{aK} in the area AA by the following equation (2). Here, in the following equation (2), Sₐ is a sum total of areas of the circuit elements Cₐₗ to C_{aK} and S_{A} is an area of the entire area AA including Sₐ.

D_{A}=Sₐ/S_{A}=ΣSₐₖ/S_{A} (2)

The design verification device 30 calculates an area share D_{B} of the circuit elements C_{bl} to C_{bL} in the area AB by the following equation (3). Here, in the following equation (3), S_{b} is a sum total of areas of the circuit elements C_{bl} to C_{bL} and S_{B} is an area of the entire area BA including S_{b}.

DB=S_{b}/S_{B}=ΣS_{bl}/S_{B} (3)

The design verification device 30 compares values between the area shares D_{A} and D_{B}, and when D_{A}<D_{B}, the design verification device 30 performs adjustment so that the value of the design threshold d_{Athij} for the area AA stored in the threshold DB 24 is smaller than the value of the design threshold d_{Brthij} for the area AB. The design verification device 30 is an example of design constraint value adjustment means.

More generally, for example, in a case where m areas 1 to m are provided for the semiconductor chip CH, the design verification device 30 calculates area shares D₁ to Dₘ of the m areas A₁ to Aₘ, and creates a table with arrangement of the calculated area shares D₁ to Dₘ in descending order of values of such, for example, D₁<D₂<D₃< . . . <Dₘ. Here, m is an integer equal to or greater than 2.

At this time, the design verification device 30 changes reference values d₁ₜₕᵢⱼ to dₘₜₕᵢⱼ for the areas A₁ to Aₘ stored in the threshold DB to have a relationship d₁ₜₕᵢⱼ<d₂ₜₕᵢⱼ<d₃ₜₕᵢⱼ< . . . dₘₜₕᵢⱼ.

The design verification device 30 uses such changed reference values d₁ₜₕᵢⱼ to dₘₜₕᵢⱼ as thresholds dᵣ₁ₜₕᵢⱼ to dₘₜₕᵢⱼ to determine whether or not an outline distance d_{i′j′} between circuit elements C_{i′} and C_{j′} included in each of the areas A₁ to Aₘ is proper. Here, i′ and j′ are any numbers that are at least 1, different from each other, and equal to or less than the number of circuit elements.

In this way, in a case where the semiconductor chip is divided into the plurality of areas, the reference value dₜₕᵢⱼ can be changed in accordance with the area share of the circuit element for each area and used as a threshold, thereby enabling reduction in occurrence of pseudo-error.

### Embodiment 5

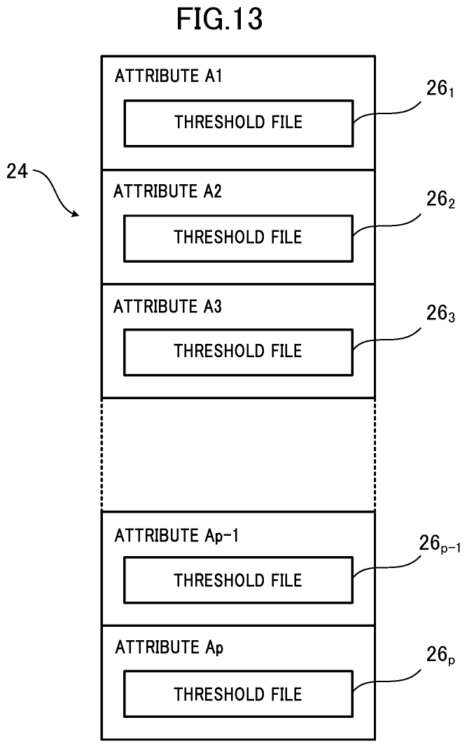

Embodiment 5 of the present disclosure is described hereinafter in detail with reference to FIG. 13.

In the present embodiment, the threshold DB 24 includes threshold files 26₁ to 26ₚ associated with p attributes 1 to p, respectively.

Examples of the attributes of the semiconductor device include, for example, an analog/digital mixed circuit, in addition to the analog circuit and the digital circuit described above. Each of the threshold files 26₁ to 26ₚ included in the threshold DB 24 includes a type of the semiconductor device or the threshold dᵣ₁ₜₕᵢⱼ to dᵣₚₜₕᵢⱼ for each area of the semiconductor device.

Upon an operator performing an operation of specifying an attribute of the semiconductor device or an attribute of each of the plurality of areas in the semiconductor device through the UI device 10, the design verification device 30 reads the threshold files 26₁ to 26ₚ corresponding to the specified attribute.

The design verification device 30 determines whether or not each outline distance dᵢⱼ between the circuit elements Cᵢ and Cⱼ is proper, using any of the threshold files 26₁ to 26ₚ corresponding to the specified attribute. Alternatively, the design verification device 30 determines whether or not the outline distance d_{i′j′} between the circuit elements C_{i′} and C_{j′} included in each of the plurality of areas is proper, using each of two or more of the threshold files 26₁ to 26ₚ corresponding to the attribute specified by each of the plurality of areas of the semiconductor device.

In this way, use of the threshold dᵣₜₕᵢⱼ proper to the attribute of the semiconductor device or the attribute of each of the plurality of areas of the semiconductor device enables reduction in occurrence of the pseudo-error of the check.

### Embodiment 6

Next, Embodiment 6 is described. In the above-described Embodiments 1 to 5, the design support system 1 sets the design constraint based on the existence probability ρ_{d} of the variable dᵢⱼ extracted from the design data. By contrast, in Embodiment 6, a design support system 1 sets the design constraint using a machine learning method based on artificial intelligence (AI). The description is given hereinafter.

A configuration of the design support system 1 according to Embodiment 6 is identical to the configuration illustrated in FIG. 1.

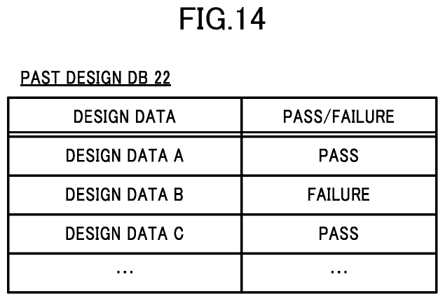

The past design DB 22 stores the verified design data. Specifically, as illustrated in FIG. 14, the past design DB 22 stores, as the verified design data, a plurality of items of design data including design data A, design data B, design data C, and so on. Each of the design data A, the design data B, the design data C, and so on is data for designing products, for example, a model A, a model B, a model C, and so on. An example of the design data A, B, C, . . . is data for designing a mounting board in an electrical/electronic device.

As illustrated in FIG. 14, each of the design data A, B, C, . . . stored in the past design DB 22 is assigned a “pass” or “fail” label based on the result of the past verification. The past verification is made, for example, by a variety of performance evaluation tests on a prototype of a product obtained based on the design data. For example, a “pass” label is assigned to the design data of the mounting board “a” determined as a pass in the performance evaluation on the electrical/electronic device, and a “fail” label is assigned to the design data of the mounting board “b” determined as a “fail”.

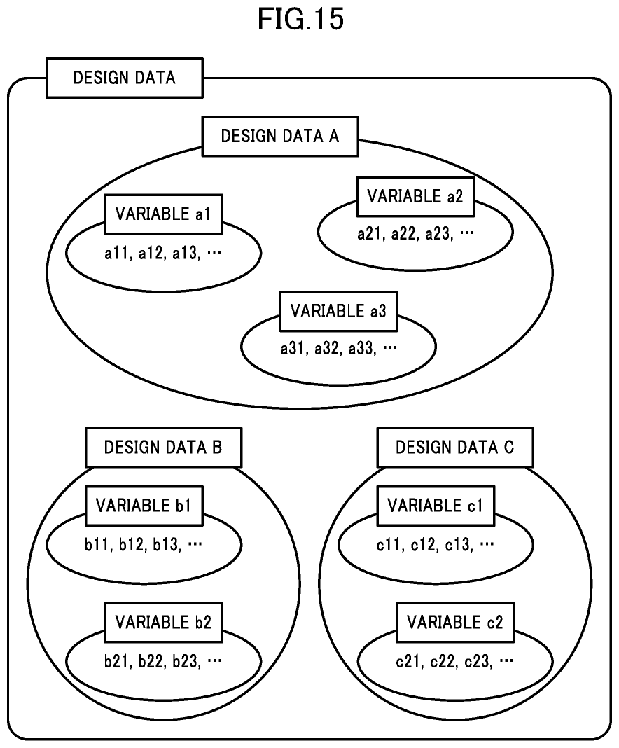

Each of the design data A, B, C, . . . stored in the past design DB 22 includes a plurality of variables that define design constraint, as illustrated in FIG. 15. More specifically, the design data A includes variables a1, a2, a3, . . . that define the design constraint. Furthermore, the variable a1 includes variable a11, a12, a13, . . . , the variable a2 includes variables a21, a22, a23, . . . , and the variable a3 includes variables a31, a32, a33, . . . . The variables all, a12, a13 included in the variable a1 are, for example, lengths of various elements included in the design data, the variables a21, a22, a23, . . . included in the variable a2 are, for example, spacings between various elements included in the design data, and variables a31, a32, a33, . . . included in the variable a3 are, for example, thicknesses between various elements included in the design data. The design data B, C, . . . also include a plurality of variables that define the design constraint, similarly to the design data A.

More specifically, in a case where the design data A, B, C, . . . are for the mounting board of the electrical/electronic device, examples of the variables include a distance to a bypass capacitor for each integrated circuit (IC) package. In this way, the design data A, B, C, . . . stored in the past design DB 22 include, as the variables that define the design constraint, a plurality of types of variables, such lengths, spacings, thicknesses, distances, or the like.

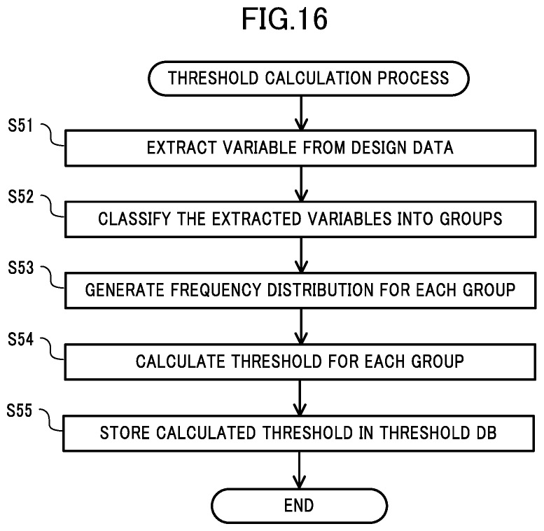

Next, a threshold calculation process executed by a threshold calculation device 20 according to Embodiment 6 is described with reference to a flowchart illustrated in FIG. 16.

The threshold calculator 23 extracts the variables that define the design constraint from the verified design data A, B, C, . . . stored in the past design DB 22 (step S51). As described above, the design data A, B, C, . . . include the plurality of types of variables a1, a2, a3, . . . , such as lengths, spacings, or the like. The threshold calculator 23 extracts the plurality of types of variables a1, a2, a3, . . . , as included in the design data A, B, C, . . . . The threshold calculator 23 is an example of variable extraction means.

Upon extraction of the variables from the design data A, B, C, . . . , the threshold calculator 23 classifies the extracted variables into a plurality of groups using a clustering method (step S52). Since each classification includes the plurality of types after classification of the variables extracted from the design data A, B, C, . . . , the design constraint that is to be satisfied by all the variables are not necessarily the same, and in general, all the variables are to satisfy different design constraints. As preprocessing, the threshold calculator 23 classifies each variable for the corresponding design constraint to set the design constraint corresponding to each variable included in the design data A, B, C, . . . .

Here, in a case where which design constraint is to be satisfied by which variable is not known, manual classification of each variable by a user is normally difficult and requires an increased amount of operator involvement. Thus the threshold calculator 23 classifies the variables into the plurality of groups using a clustering method that is one type of unsupervised machine learning. The threshold calculator 23 is an example of classification means.

The threshold calculator 23 uses a k-means method as the clustering method. More specifically, the threshold calculator 23 classifies variables into k groups by executing the following processes (1) to (4).

(1) Classify the variables into k groups arbitrarily. The value k is set by a user beforehand. For example, a number that could be a target of a conventional design constraint is input as an initial value of k. That is, a sum total of the number of the variables that all the design constraints use is input as the initial value of k.
(2) Calculate the barycenter of each group. A parameter for calculation of the barycenter can use information such as the size of the variable, positional coordinates, or the like.
(3) Calculate a distance between the barycenter of each group and each variable, and reclassify the variables as belonging to the group corresponding to the barycenter having the shortest distance.
(4) Repeat the processing (2) and (3) until the change of the barycenter of each group is not more than a predetermined value.

As a result of classification by the threshold calculator 23, the same type of variables may be classified into two or more different groups. In other words, since the plurality of design constraints use the same type of variable, the types of the variables after classification are not limited to having all different types among the plurality of groups but may have redundancy among the plurality of groups. For example, the variable corresponding to the length may be classified into each of the plurality of different groups, or the variable corresponding to spacing may be classified into each of the plurality of different groups. The plurality of types of variables may be included in one group. For example, the variable corresponding to the length and the variable corresponding to the spacing may be classified into the same group.

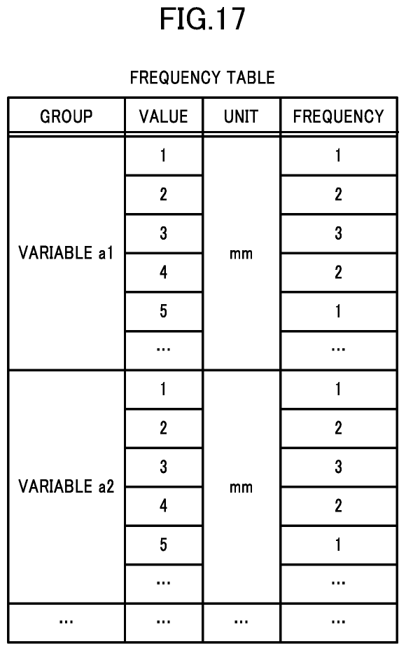

Upon classification of the variables into the plurality of groups, the threshold calculator 23 generates a frequency distribution of the variable for each group (step S53). More specifically, the threshold calculator 23 generates a frequency table as illustrated in FIG. 17. As an example, FIG. 17 illustrates a case where the variables extracted from the design data A, B, C, . . . are classified into a group of the variable a1 and a group of the variable a2.

The threshold calculator 23 generates the frequency distribution of the variable included in each group. More specifically, the threshold calculator 23 counts a frequency of the variable taking each value in such a way that the variable having 1 mm among the plurality of variables included in the group of the variable a1 is given 1, the one having 2 mm is given 2, . . . . The threshold calculator 23 also counts the frequency of the variable taking each value similarly for another group such as the group of the variable a2. In this way, the threshold calculator 23 generates the frequency table as illustrated in FIG. 17 by counting the frequency of the variable included in each of the plurality of groups.

The threshold calculator 23 generates such a frequency distribution table for each of the variables extracted from the design data assigned a “pass” label and the variable extracted from the design data assigned a “fail” label. The threshold calculator 23 thereby generates the frequency distribution determined as a “pass” and the frequency distribution determined as a “fail” for each of the plurality of groups.

With reference again to the threshold calculation process illustrated in FIG. 16, upon generation of the frequency distribution, the threshold calculator 23 calculates, based on the generated frequency distribution, a threshold that is a value indicating the design constraint for each group (step S54). More specifically, the threshold calculator 23 analyzes the generated frequency distribution using the unsupervised machine learning for each of the plurality of groups. The threshold calculator 23 thereby sets the design constraint to be satisfied by the variables in each group. In an example of the mounting board, the threshold calculator 23 calculates the design constraint on a distance to a capacitor for each package of the IC mounted on the mounting board, based on a group of data of the variables extracted from the design data determined as a “pass” and a group of data of the variables extracted from the design data determined as a “fail”.

As an example, FIG. 19 illustrates a “pass” frequency distribution and a “fail” frequency distribution for a certain one group. The threshold calculator 23 seeks a boundary of division between the “pass” frequency distribution and the “fail” frequency distribution according to the unsupervised machine learning.

More specifically, the threshold calculator 23 calculates, using as the boundary an initial value of a predetermined threshold, a proportion of the variables that exist on the pass side to the variables that exist on the fail side among the “pass” frequency distribution and a proportion of the variables that exist on the pass side to the variables that exist on the fail side among the “fail” frequency distribution. Then the threshold calculator 23 updates the threshold from the initial value so that both of the proportion of the variables that exist on the pass side among the “pass” frequency distribution and the proportion of the variables that exist on the fail side among the “fail” frequency distribution get higher appropriately.

Here, an example of a method for calculating a threshold by the unsupervised machine learning is described. The threshold calculator 23 sets a temporary threshold d, and calculates a pass area Sp(d) and a fail area Sf(d) determined by the threshold d. Then the threshold calculator 23 calculates an average pass area Spave(d) obtained by averaging the pass area Sp(d) by sample number of the parameter by the following equation (1) and calculates an average fail area Sfave(d) obtained by averaging the fail area Sf(d) by sample number of the parameter by the following equation (2). In the equations (1) and (2), n and m represent sample numbers of parameters.

$$\begin{matrix}( Equation 1 ) & \\ Spave ( d ) = \frac{1}{n} {\sum }^{n} Sp ( d ) & ( 1 ) \\ ( Equation 2 ) & \\ Sfave ( d ) = \frac{1}{m} {\sum }^{m} Sf ( d ) & ( 2 )\end{matrix}$$

Upon calculation of the average pass area Spave(d) the average fail area Sfave(d), the threshold calculator 23 calculates an evaluation function J(Spave(d), Sfave(d)) represented by these areas. The threshold calculator 23 calculates the evaluation function J (Spave(d), Sfave(d)) by varying the value of the threshold d, and seeks the threshold d for which the evaluation function J (Spave(d), Sfave(d)) is maximum. As a result of seeking the threshold d, the threshold calculator 23 sets, as a final threshold, a threshold d for which the evaluation function J(Spave(d), Sfave(d)) is maximum.

The accuracy of the threshold calculated by such machine learning increases with the increased number of the design data A, B, C, . . . stored in the past design DB 22, that is, the increased number of the variables. Also, by using as the initial value an existing threshold known by a user, the accuracy of the calculated threshold can be increased. The threshold calculator 23 is an example of setting means.

In a case where a difference between the threshold that is the design constraint value obtained by the machine learning and the threshold that is the existing design constraint value is greater than a predetermined assumed value, the threshold calculator 23 outputs a warning via the UI device 10. In other words, in a case where the design constraint obtained by the machine learning is out of range assumed for the existing design constraint, the threshold calculator 23 notifies the user by issuing a warning.

However, even when the warning is issued, the user is able to use the design constraint obtained by the machine learning. The reason for such ability is because, even with the design constraint out of the assumed range, as long as the design constraint is obtained by the machine learning, the design constraint still has a possibility of obtaining a target performance. For example, the threshold calculator 23 receives from the user through the UI device 10 an instruction of whether or not to use the design constraint value for which the warning is issued. When the instruction to use the design constraint value for which the warning is issued is received, the design verification device verifies the new design data 31 using the design constraint value.

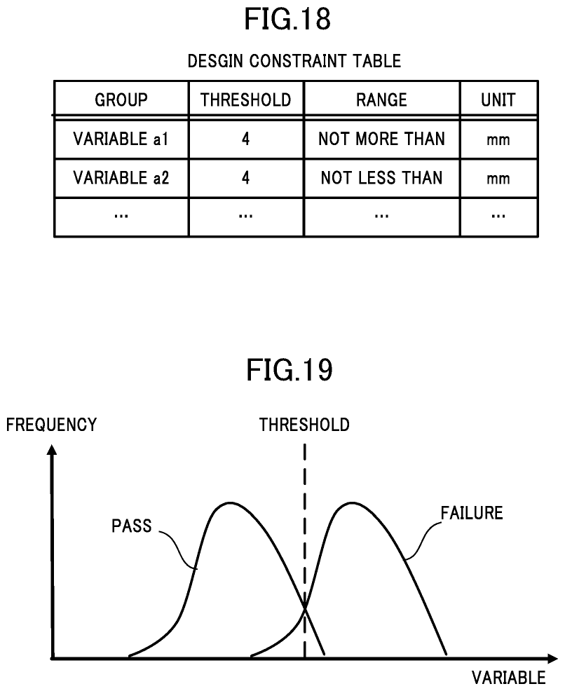

With reference again to the threshold calculation process illustrated in FIG. 16, upon calculation of the threshold for each group, the threshold calculator 23 stores the calculated threshold in the threshold DB 24 (step S55). More specifically, the threshold calculator 23 generates a design constraint table illustrated in FIG. 18 and stores the generated design constraint table in the threshold DB 24. The design constraint table is a table that stores the design constraint calculated for each of the plurality of groups so as to be identifiable for each group. In an example of the FIG. 18, the design constraint table defines as the design constraint in the group of variable a1 that the variable a1 is 4 mm or less, and as the design constraint in the group of variable a2 that the variable a2 is 4 mm or more.

By generating the design constraint table in this way, the threshold calculator 23 sets the design constraint in each of the plurality of groups. The threshold DB 24 is an example of a design constraint storage that stores the plurality of design constraints.

As described above, the design support system 1 according to Embodiment 6 extracts from the verified design data the variables that define the design constraints and classifies the extracted variables into the plurality of groups using the clustering method. Then the design support system 1 according to Embodiment 6 sets the threshold that is a value indicating the design constraint for each group, by analyzing, using machine learning, the frequency distribution of the variables in each of the plurality of groups. In this way, since the design constraint is set using the machine learning, a procedural process by mathematical modelling is unnecessary. Thus even if mathematically modelling the frequency distribution of the variables is difficult since the frequency distribution has an unexpected form, the economical and reasonable design constraint for which the performance of the design product does not exceed the target value excessively can be easily set.

In Embodiment 6, the threshold calculator 23 classifies all the variables extracted from the design data A, B, C, . . . into the plurality of groups by the clustering method. However, before classification process, the threshold calculator 23 may select some of the variables to be classified from the variables extracted from the design data A, B, C, . . . . For example, the threshold calculator 23 receives from the user through the UI device 10 a choice of variables for defining the design constraints from among the variables included in the design data A, B, C, . . . . Then the threshold calculator 23 may classify the received variables into the plurality of groups using the clustering method.

In Embodiment 6, the threshold calculator 23 sets the threshold as the design constraint based on the “pass” frequency distribution and the “fail” frequency distribution. However, the threshold calculator 23 may generate the frequency distribution of the variables extracted only from the design data assigned the “pass” label, and set the design constraint based only on the “pass” frequency distribution. More specifically, the threshold calculator 23 calculates the threshold that is a value indicating the design constraint to be satisfied by the variables, by analyzing the “pass” frequency distribution using unsupervised machine learning. Even with the design constraint set only based on the “pass” frequency distribution, although the accuracy compared with the case based on the “pass” and “fail” frequency distributions decreases, the similar quality of effects can be obtained.

### Embodiment 7

Next, Embodiment 7 is described. In the above-described Embodiment 6, the threshold calculator 23 classifies the variables extracted from the design data A, B, C, . . . into the plurality of groups using the clustering method. In contrast, in Embodiment 7, information that the variables included in the design data A, B, C, . . . are to be a target of which design constraint among the plurality of design constraints is provided beforehand.

The configuration of the design support system 1 according to Embodiment 7 is identical to the configuration illustrated in FIG. 1.

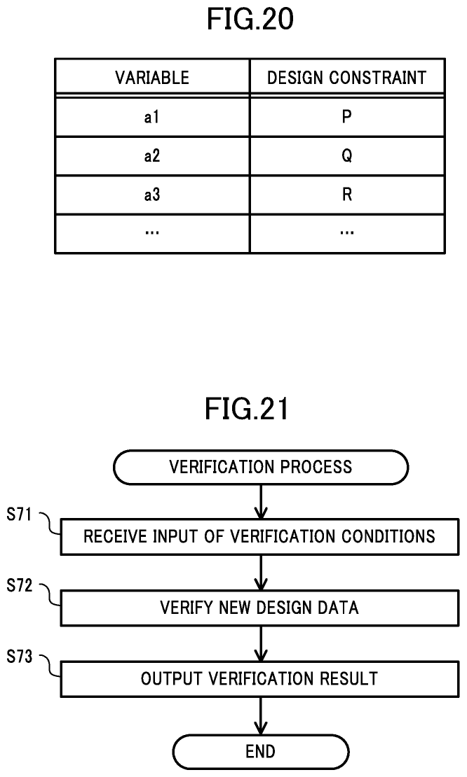

Similarly to Embodiment 6, the past design DB 22 stores the verified design data A, B, C, . . . assigned a “pass” label or a “fail” label to each of the design data. In Embodiment 7, the past design DB 22 further stores beforehand a correspondence between the variables and the design constraints as illustrated in FIG. 20. The correspondence illustrated in FIG. 20 defines each of the variables such as lengths, spacing, thicknesses, distances, or the like included in the design data A, B, C, . . . as to which is a target design constraint of the plurality of design constraints P, Q, R, . . . .

The threshold calculation device 20 according to Embodiment 7 executes a process similar to the threshold calculation process in Embodiment 6 illustrated in FIG. 16. However, since the design constraint corresponding to each variable is predetermined, the classification process of step S52 is different from that of Embodiment 6.

More specifically, the threshold calculator 23 extracts a variable that defines the design constraint from the verified design data A, B, C, . . . stored in the past design DB 22 (step S51). Upon extraction of the variable, the threshold calculator 23 classifies the extracted variable into a group of the corresponding design constraint (step S52). More specifically, the threshold calculator 23 classifies the extracted variable into the group of the design constraint corresponding to the variable, with reference to the correspondence between the variables stored in the past design DB and the design constraint.

Upon classification of the variables, the threshold calculator 23 generates a frequency distribution of the variable for each group (step S53). Upon generation of the frequency distribution, the threshold calculator 23 calculates the threshold that is a value indicating the design constraint for each group based on the generated frequency distribution (step S54). Upon calculation of the threshold, the threshold calculator 23 stores the calculated threshold in the threshold DB 24 (step S55). Since the process of steps S53 to S55 is similar to those of Embodiment 6, the description is omitted.

As described above, the design support system 1 according to Embodiment 7 extracts from the verified design data the variables that define the design constraints, and classifies the extracted variables into a plurality of groups prepared beforehand for each design constraint. Then the design support system 1 according to Embodiment 7 sets the threshold that is the design constraint for each group, by analyzing, using machine learning, the frequency distribution of the variable in each of the plurality of groups. In addition to the effects of Embodiment 6, since the correspondence between the variables and the design constraints is predetermined, an effect is obtainable that is the ability to set constraints also with respect to variables that cannot be classified by the clustering method.

### Embodiment 8

Next, Embodiment 8 is described. A design support system 1 according to Embodiment 8 performs design verification of new design data using the design constraint set by the threshold calculation device 20 according to Embodiments 6 and 7.

Configuration of the design support system 1 according to Embodiment 8 is identical to the configuration illustrated in FIG. 1. The threshold DB 24 stores the design constraint table generated by the threshold calculation device 20 according to Embodiments 6 and 7.

A verification process executed by the design verification device 30 according to Embodiment 8 is described with reference to a flowchart illustrated in FIG. 21.

Upon start of the verification process, the design verification device 30 receives an input of a verification condition that is a condition during performance of the design verification (step S71). More specifically, the design verification device 30 receives, as a verification condition, from the user through the UI device 10 a choice of the design constraint applied to the new design data 31 among the plurality of the design constraints stored in the threshold DB 24. The design verification device 30 also receives, as a verification condition, from the user through the UI device 10 a choice of the types, variables, and the like of the new design data 31 to be verified. The UI device is an example of reception means.

Upon reception of the input of the verification condition, the design verification device 30 verifies the new design data 31 (step S72). More specifically, the design verification device 30 extracts from the new design data 31 the variables to be verified received in step S71. Then the design verification device 30 verifies, with reference to the design constraint table stored in the threshold DB 24, whether or not the to-be-applied design constraint previously received in step 71 is satisfied by the extracted variables. The design verification device 30 is an example of design verification means.

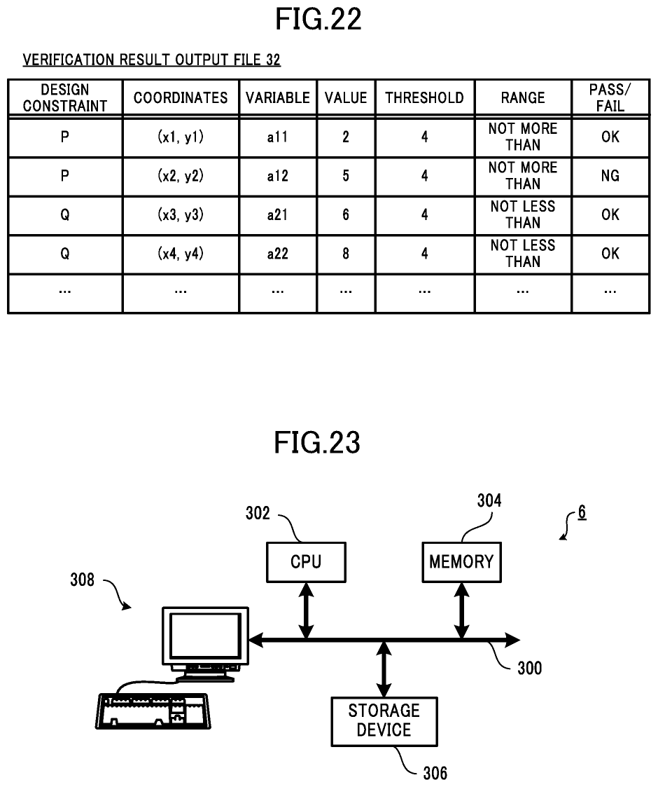

Upon verification of the new design data 31, the design verification device outputs the verification result (step S73). More specifically, the design verification device 30 writes, into the verification result output file 32 illustrated in FIG. 22, output information indicating whether or not each variable included in the new design data 31 satisfies the design constraint.

In an example of FIG. 22, the variable a11 that exists in coordinates (xl, yl) satisfies the design constraint since the value is 4 mm or less. Thus the design verification device 30 determines that the variable a11 is given a pass. In contrast, the variable a12 that exists in the coordinates (x2, y2) does not satisfy the design constraint since the value is 4 mm or more. Thus the design verification device 30 determines that the variable a12 is given a fail.

The design verification device 30 outputs to the exterior, by display on the UI device 10, the output information indicating whether or not each variable included in such new design data 31 satisfies the design constraint. The UI device 10 is an example of output means for outputting the output information.

As described above, the design support system 1 according to Embodiment 8 verifies the new design data 31 using the design constraint set automatically with high accuracy by machine learning. This enables verification of whether or not the performance of the design product satisfies the target value.

In Embodiment 8, the design verification device 30 verifies the new design data 31 using the design constraint set using the machine learning method by the threshold calculation device 20 according to Embodiments 6 and 7. However, the design verification device 30 may be designed to be able to switch, as to the design constraint to be used for verification, the design constraint set by machine learning and the existing design constraint set independently of machine learning. For example, the design verification device 30 may receive, from a user as one of verification conditions in step S71, a choice as to which of the design constraint is to be used for verification, the design constraint set by machine learning or the existing design constraint set independently of machine learning, for each variable included in the new design data 31.

The design verification device 30 is not limited to using as is the design constraint that is set by the threshold calculation device 20 according to Embodiment 6 and 7, and may verify the new design data 31 using new design constraint obtained by modifying the design constraint set by the threshold calculation device 20. For example, the design verification device 30 may verify the new design data 31 using a new threshold obtained by multiplying the threshold set by the threshold calculation device 20 by a safety factor. The safety factor may be predetermined or may be received from a user as one of the verification conditions in step S71.

The threshold calculator 23 may update the design constraint by Bayesian updating based on the verification result as to whether the variables verified by the design verification device 30 and included in the new design data 31 satisfy the design constraint. More specifically, the threshold calculator 23 updates the “pass” frequency distribution by adding the frequency of the variable, extracted from the new design data 31 and determined as a “pass” by verification, to the machine-learning-based “pass” frequency distribution. The threshold calculator 23 also updates the “fail” frequency distribution similarly. Then the threshold calculator 23 sets new design constraint by analyzing, using unsupervised machine learning, the updated “pass” and “fail” frequency distributions. By updating the design constraint sequentially by Bayesian updating in this way, the design constraint can be set with higher accuracy.

Furthermore, the threshold calculator 23 may receive, from a user, a modification to the verification result of verification by the design verification device 30 and modify the design constraint based on the verification result with the received modification added. More specifically, the user enters through the UI device 10 the modification to the verification result of each variable output to the verification result output file 32. For example, the user may modify the verification result of the variable determined as a “pass” in the verification by the design verification device 30 to be given a fail based on the user's determination. Alternatively, the user may modify the verification result of the variable determined as a fail in the verification by the design verification device 30 to be given a pass based on the user's determination. Upon reception of the modification to the verification result, the threshold calculator 23 updates the “pass” and “fail” frequency distributions by adding the frequency of the “pass” and “fail” variables in the modified verification result to the machine-learning-based “pass” and “fail” frequency distributions, respectively. Then the threshold calculator 23 sets new design constraint by analyzing, using unsupervised machine learning, the updated “pass” and “fail” frequency distribution. This enables more flexible setting of the design constraint in consideration of the user's determination.

FIG. 23 is a diagram illustrating a hardware configuration of a computer 6 that implements the design support system 1 according to the above-described Embodiments 1 to 8. As illustrated in FIG. 23, the computer 6 is configured to include a central processing unit (CPU) 302 that executes command codes of a program, a memory 304 including a random access memory (RAM), a read only memory (ROM), and the like, a storage 306 including a hard disk drive (HDD), a solid state drive (SSD), and the like, a display device, a mouse, and the like, and an input/output device 308 usable as the UI device 10 is connected through a bus 300.

Each component of the design support system 1 illustrated in FIG. 1 is implemented by the program running on the computer 6. Such a program may be distributed in any method, and for example, may be stored for distribution in a computer-readable recording medium, such as a compact disk read only memory (CD-ROM), a digital versatile disk (DVD), a magneto-optical disk (MO), a memory card, or the like, or may be distributed through a communication network such as the Internet or the like.

Each component of the design support system 1 is not limited to the CPU 302, the memory 304, and the like illustrated in FIG. 23, and can be implemented, for example, by a combination of a digital circuit, an analog circuit, and a field programmable gate array (FPGA), and a program executable by a microcontroller or the like. The CPU 302, the digital circuit, the analog circuit, FPGA, and the like that operate each component of the design support system 1 can be collectively referred to as a controller or a processor.

Embodiments 1 to 8 can be freely combined as long as inconsistencies are avoided. Embodiments 1 to 5 illustrates a case where the design support system 1 verifies the design data of the semiconductor device, but the design support system 1 is used for verification of the design data of a freely-selected electric circuit, electronic circuit, mechanical device, or the like.

Embodiments 1 to 8 illustrate a case of verifying two-dimensional design data, but the design support system 1 can be used for generation of the threshold data of the three-dimensional design data and verification of the design choices. The circle is given as an example of the shape of the circuit element but the shape of the component can be freely selected.

When the circuit elements Cᵢ and Cⱼ have a shape other than the circle, points used for defining the circuit element distance Dᵢⱼ, the outline distance dᵢⱼ therebetween, and the like can be, for example, points defined as centers of these elements, positions of the barycenters of these elements, or the like. The reference point can be set in accordance with shapes of the circuit elements.

In Embodiments 1 to 5, the threshold calculator 23 extracts, from the verified design data, a variable that does not satisfy the first design constraint, and sets, based on an existence probability of the extracted variable, the second design constraint that is more relaxed than the first design constraint. However, not providing the first design constraint may be an option. In a case of not providing the first design constraint, the threshold calculator 23 extracts, from the verified design data, the variables that define design constraint, regardless of whether or not the variable satisfies the first design constraint. More specifically, the threshold calculator 23 extracts the outline distance dᵢⱼ for all the combination of two adjoining circuit elements Cᵢ and Cⱼ. Then the threshold calculator 23 may set the design constraint based on the existence probability of the extracted variable. In a case of not providing the first design constraint, the design support system 1 may omit inclusion of the design reference DB 21 that stores the first design constraint. The same applies to the subsequent embodiments.

By contrast, in Embodiments 6 and 7, the threshold calculator 23 extracts, from the design data A, B, C, . . . all the variables that define the design constraints, regardless of whether the variables satisfy the first design constraint. However, in a manner similar to that of Embodiments 1 to 5, the threshold calculator 23 may extract, from the design data A, B, C, . . . the variable that does not satisfy the first design constraint, and set, based on the frequency distribution of the extracted variable, the second design constraint that is more relaxed than the first design constraint.

The design reference DB 21, the past design DB 22, and the threshold DB 24 are not limited to being included inside the design support system 1, but may be provided outside of the design support system 1. For example, each DB may be provided in a data server that provides resources in cloud computing. In this case, the design support system 1 communicates a data server via a wide area network such as the Internet, thereby writing data in each DB and reading data from each DB.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of International Patent Application No. PCT/JP2019/034386, filed on Sep. 2, 2019, including the specification, claims, drawings, and abstract, the entire disclosure of which is incorporated by reference herein.

### REFERENCE SIGNS LIST

1 Design support system
3 Computer
300 Bus
302 CPU
304 Memory
306 Storage device
308 Input/output device
10 UI device
20 Threshold calculation device
21 Design reference DB
22 Past design DB
23 Threshold calculator
24 Threshold DB
26 Threshold file
30 Design verification device
31 New design data
32 Verification result output file
40 CAD device

1. A design support system, comprising:
a variable extractor to extract from verified design data a variable that defines a design constraint;
a classifier to classify the variable extracted by the variable extractor into a plurality of groups; and
a setter to set, for each of the plurality of groups, the design constraint by analyzing, using statistical processing or machine learning, a frequency distribution of the variable classified by the classifier for each of the plurality of groups.

2. A design support system, comprising:
a variable extractor to extract from verified design data a variable that defines a design constraint;
an existence probability acquirer to find an existence probability of the extracted variable;
a cumulative existence probability acquirer to find a cumulative existence probability of the found existence probability; and
a setter to identify a value of the variable that is a value when the cumulative existence probability matches a preset reference value and set the identified value to a design constraint value of the design constraint.

3. The design support system according to claim 2, wherein
the variable extractor extracts a plurality of variables that define the design constraint,
the existence probability acquirer finds the existence probability of each variable of the extracted plurality of variables,
the cumulative existence probability acquirer finds a cumulative existence probability of the existence probability of each of the plurality of variables, and
the setter sets, to the design constraint value of the design constraint, each of values of the plurality of variables that are values when the cumulative existence probability matches the preset reference value.

4. The design support system according to claim 2, wherein
the existence probability acquirer finds from the found existence probability, one or more new existence probabilities based on an attribute, and
the cumulative existence probability acquirer finds a cumulative existence probability of the new existence probabilities.

5. The design support system according to claim 2, wherein
the existence probability acquirer finds, when the found existence probability has a plurality of extreme values, a plurality of new existence probabilities to separate the plurality of extreme values,
the cumulative existence probability acquirer finds a cumulative existence probability of each of the plurality of new existence probabilities, and
the setter identifies a value of the variable that is a value when each of the cumulative existence probabilities matches the preset reference value and sets the identified value to the design constraint value of the design constraint.

6. The design support system according to claim 1, wherein
the variable extractor extracts from the verified design data, as a variable that defines the design constraint, a variable that does not satisfy a first design constraint set at a design phase, and
the setter sets a second design constraint that is more relaxed than the first design constraint, by analyzing, using the statistical processing or the machine learning, the frequency distribution of the variable extracted by the variable extractor.

7. The design support system according to claim 6, further comprising:
a design reference storage to store the first design constraint defining that the value of the variable is equal to or greater than a first design constraint value or equal to or less than the first design constraint value, wherein
the variable extractor extracts from the verified design data the variable having a value less than or greater than the first design constraint value.

8. The design support system according to claim 1, further comprising a design constraint value adjuster to find a share of a plurality of components in an area of a device to be designed and adjust a design constraint value in accordance with the share of the plurality of components.

9. The design support system according to claim 1, further comprising a design constraint value adjuster to find a share of a plurality of components in an area of a device to be designed, for each of a plurality of areas and adjust a design constraint value for each of the plurality of areas in accordance with a share of the plurality of components for each of the plurality of areas.

10. The design support system according to claim 8, wherein the design constraint value adjuster adjusts the design constraint value to be higher for a higher share of the plurality of components.

11. The design support system according to claim 2, further comprising:
a classifier to classify the variable extracted from the verified design data into a plurality of groups, wherein
the setter sets, for each of the plurality of groups, the design constraint based on a frequency distribution of the variable classified by the classifier for each of the plurality of groups.

12. The design support system according to claim 1, wherein the classifier classifies the variable extracted from the verified design data into the plurality of groups using a clustering method.

13. The design support system according to claim 1, wherein the setter sets the design constraint by analyzing, using unsupervised machine learning, the frequency distribution of the variable extracted by the variable extractor.

14. The design support system according to claim 13, wherein
the variable extractor extracts the variable from each of design data determined as a pass through verification and design data determined as a fail through the verification, and
the setter sets the design constraint by analyzing, using the unsupervised machine learning, a frequency distribution of variable extracted from the design data determined as the pass and a frequency distribution of variable extracted from the design data determined as the fail.

15. The design support system according to claim 1, further comprising a design verifier to verify whether or not a variable included in new design data satisfies the design constraint set by the setter.

16. A design support system, comprising:
a variable extractor to extract from verified design data a variable that defines a design constraint;
a setter to set the design constraint by analyzing, using statistical processing or machine learning, a frequency distribution of the variable extracted by the variable extractor;
a design verifier to verify whether or not a variable included in new design data satisfies the design constraint set by the setter; and
a receiver to receive a choice of the design constraint to be applied to the new design data from a plurality of design constraints, wherein
the design verifier verifies whether or not the variable included in the new design data satisfies the design constraint received by the receiver.

17. The design support system according to claim 15, wherein the setter updates the design constraint based on a verification result of whether or not the variable verified by the design verifier and included in the new design data satisfies the design constraint.

18. The design support system according to claim 17, wherein the setter receives modification to the verification result from a user, and updates the design constraint based on the verification result to which the modification is added.

19. A design support method executable by the design Support system according to claim 1.

20. A non-transitory computer-readable recording medium storing a program, the grogram causing a computer to function as the design support system according to claim 1.
